(19) United States
(12) Patent Application Publication
(10) Pub. No.: US 2002/0146985 A1
(43) Pub. Date: Oct. 10, 2002

(54) Battery operated remote transceiver (BORT) system and method

(75) Inventor: Gary Allen Naden, Mandeville, LA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Axonn Corporation, New Orleans, LA

(21) Appl. No.: 09/774,027

(22) Filed: Jan. 31, 2001

(51) Int. Cl. H04B 17/00

(52) U.S. Cl. 455/70; 455/574; 455/343; 455/67.1

(57) ABSTRACT

A system, method, and computer program product for reducing power consumption in remote communications, wherein a system transceiver transmits in a system transceiver message a count value and modulated communication data, and a remote transceiver polls for the count value indicative of a scheduled broadcast time for broadcast of the modulated communication data. The remote transceiver conserves power during a time period prior to the scheduled broadcast time and synchronizes an on-time of the remote transceiver with the scheduled broadcast time of the system transceiver. The remote transceiver conserves power both by polling rather than continuously listening and by entering a low-power sleep period for a time period prior to the scheduled broadcast time.

### CROSS REFERENCE TO RELATED DOCUMENTS

This application claims benefit of priority to U.S. Disclosure Document No. 438162 filed in the United States Patent and Trademark Office on Jun. 29, 1998, the entire disclosure of which is incorporated herein by reference.

### BACKGROUND OF THE INVENTION

1. Field of the Invention

The present invention relates to communications-related systems and methods. More particularly, it relates to reduced power consumption in battery-powered receivers and/or transceivers. It also relates to an improved receiver sampling algorithm whereby the receiver achieves initial signal correlation.

2. Description of the Background

In a prior commonly owned U.S. patent application Ser. No. 08/929,891, the entire contents of which is incorporated herein by reference a network that contains both battery-operated and line-powered transceivers is discussed. To maintain network coherency, the battery-operated devices are required to wake up at specific intervals to receive messages from the line-powered transceivers. Due to device limitations, there is ambiguity in the wake up timer of the battery-operated devices. Therefore, these Battery-Operated Remote Transceiver (BORT) devices have to wake up inside a specified window, during which time they receive a transmission with a long preamble, or leader. The leader is of sufficient length to allow for maximum error of the crystal oscillators.

In the previously disclosed BORT device, a system with 100 parts per million (ppm) clock error and with a 5 second message interval would require a message preamble of 8.3 milliseconds (ms). Of this amount, 500 microseconds (ms) is required for clock error and 7.8 ms is required for uncertainty in the BORT device sleep timer.

Once the BORT device becomes active and acquires the leader, it must remain active during the entire leader, waiting for data. For long leaders, this technique shortens battery life. For crystal oscillators with large error, either (1) the leader length increases or (2) the wake up window occurs with great frequency. Either of these approaches decreases battery life.

### SUMMARY OF THE INVENTION

Accordingly, it is an object of the present invention to maintain network coherency without decreasing battery life in a remote communication device One object of the present invention is to transmit count values in a preamble prior to transmission from a system transceiver of modulated communication data. The count values enable the remote communication device to determine when the modulated communication data will be transmitted, thus allowing the remote devices to “sleep” (i.e. conserve power) until it is time to “awake” (i.e. receive) the transmitted communication data.

It is therefore a further object of the present invention to provide a device that can ascertain network timing patterns from a variety of remote devices whose individual clocks may be at variance.

Another object of the invention is to achieve initial signal correlation with an improved sampling algorithm.

It is therefore a further object of the present invention to reduce the likelihood that the remote device polling recurrently for an indication of transmitted data from the system transceiver will not mistake radio silence (i.e., no transmission) for a transmission with ‘0’ values in a transmission string such as for example a leader to the count value.

These and other objects are provided for in a novel system, method, and computer program product for reducing power consumption in a remote communications system, wherein a system transceiver transmits in a system transceiver message a count value and modulated communication data, and a remote transceiver polls for the count value indicative of a scheduled broadcast time for broadcast of the modulated communication data. The remote transceiver conserves power during a time period prior to the scheduled broadcast time and synchronizes an on-time of the remote transceiver with the scheduled broadcast time of the system transceiver. The remote transceiver conserves power both by periodic polling rather than continuously listening and by entering a low-power sleep period for a time period prior to the scheduled broadcast time.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a diagram showing a transmitted data packet message;

FIG. 1B is a schematic diagram of a communication system according to the present invention;

FIG. 2 is a timing diagram that shows transmit and receive operations performed by two BORT devices and one system transceiver;

FIG. 3 is diagram showing how two data samples that are separated in time increase the chances of signal acquisition;

FIG. 4A is a logic flow diagram that explains the use of two data samples in signal acquisition;

FIG. 4B is a flow diagram showing wake-up procedure for each BORT device;

FIG. 5 is a diagram showing that two consecutive data samples increases the chances of signal acquisition;

FIG. 6 is a diagram showing that certain count sequences can be omitted from the long preamble to increase the probabilities of successful signal acquisition;

FIG. 7 shows a schematic diagram of a receiver sampling from two symbol periods to achieve signal correlation; and

FIG. 8 is a schematic illustration of a computer system programmed to perform one or more of the special purpose functions of the present invention.

### DETAILED DESCRIPTION OF THE PREFERRED EMBODIMENTS

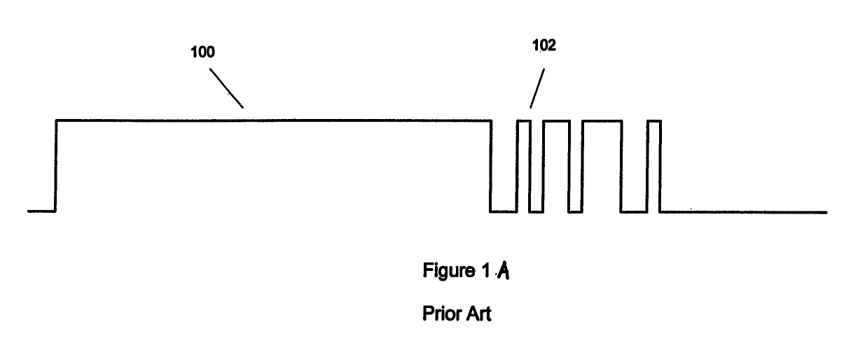

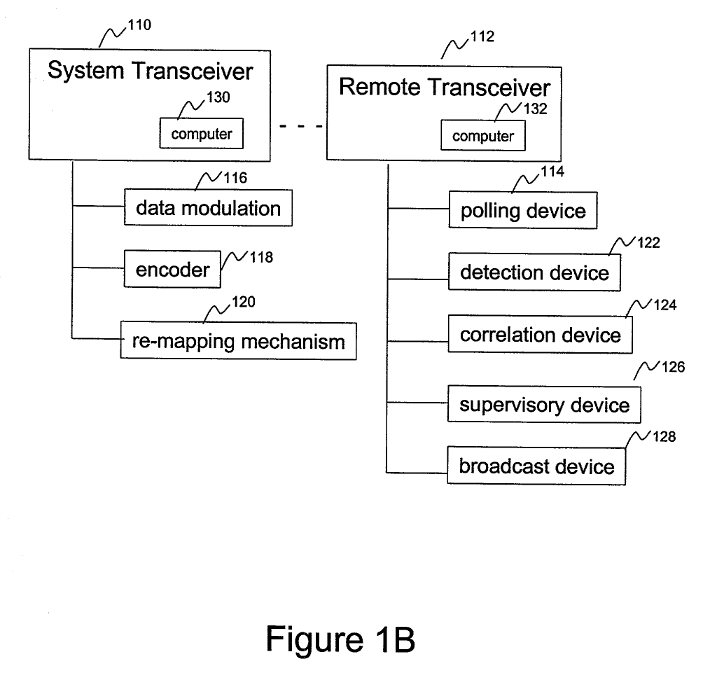

Various other objects, features and attendant advantages of the present invention will be more fully appreciated as the same becomes better understood from the following detailed description when considered in connection with the accompanying drawings in which like reference characters designate like or corresponding parts throughout the several views and wherein FIG. 1A shows a transmitted data package message with a preamble section 100 and a data modulation section 102 including modulated data. The preamble section 100 permits a receiver to perform a frequency “lock” also to perform and a spreading-code coherency lock for direct sequence spread spectrum (DSSS) systems.

FIG. 1B shows a schematic diagram of a communication system according to the present invention. In FIG. 1, a system transceiver 110 is in communication with a remote transceiver 112 such that the system transceiver 110 transmits a count value indicating a schedule broadcast time for transmitting modulated communication data. The remote transceiver 112 includes a polling device 114 which repeatedly poles on a predetermined schedule to sample for the count value. When not polling for the count value, the remote transceiver 112 remains in a low-power state which reduces power consumption. Upon receiving the count value, the remote transceiver 112 schedules and synchronizes an on time with the schedule of the system transceiver 110.

The system transceiver 110 includes a data modulator 116 which transmits the modulated communication data, the transmission occurring over a time interval which is longer than a time between repeated pollings of the remote transceiver 112. The total transmission is longer than then the interval between pollings, but the data modulation portion is shorter than the interval between pollings. The data modulator 116 transmits the modulated communication data in a data modulation section preceded by a preamble. The preamble contains count values indicating the time period prior to the scheduled broadcast. Further, the system transceiver 110 includes an encoder 118 and a re-mapping mechanism 120, both of which serve to reduce the probability that the remote transceiver will poll a null value (see detailed discussion below).

The remote transceiver 112 further includes a detection device 122, a correlation device 124, a supervisory device 126, and a broadcast device 128. The detection device 122 detects a correlation event occurring when a transmitted signal from the transceiver changes from a low value to a high value. The correlation device 124 correlates together high value transmitted signals. The supervisory device 126 broadcasts a supervisory message to the system transceiver to maintain positive communication. The broadcast device 128 broadcasts an alarm message to the system transceiver to transfer system status information.

The communication system is controlled by a computer system including computers 130 and 132 on the system and remote transceivers, respectively. The computers are programmed to facilitate communications between the system transceiver 110 and the remote transceiver 112. Each computer operates with standard protocol and system components, as is known by those skilled in the computer art. A discussion of a system configuration for computers 130 and 132 will be discussed below once the specifics of the communication between the system and remote transceivers has been expounded.

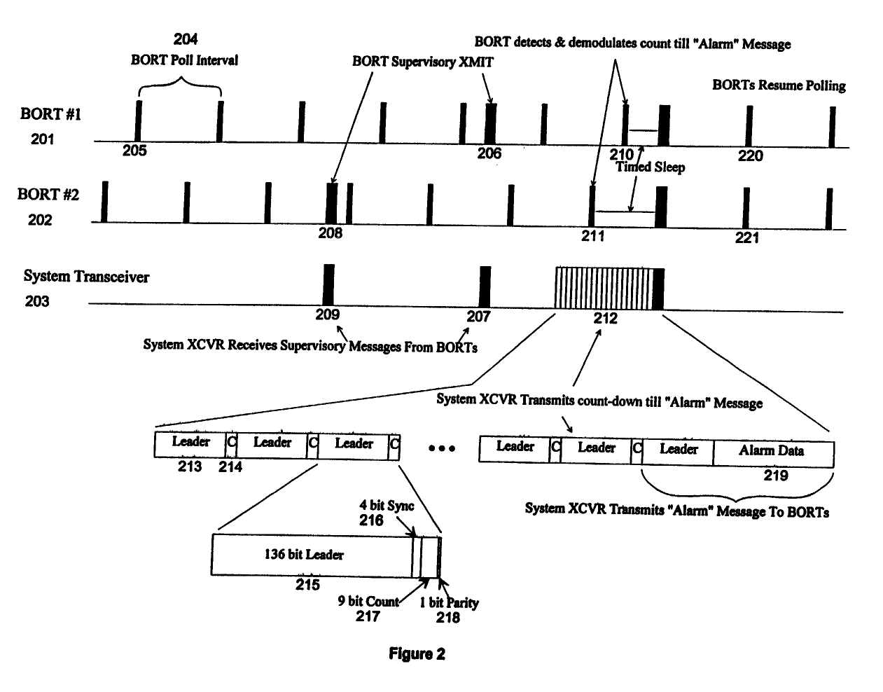

Current applications require that a BORT device reliably receive an alarm (i.e. a non-deterministic) transmission from a transmitter. To insure reliability, the transmission includes a preamble of sufficient length to allow the BORT device to wake up and demodulate transmitted data from the transmitter. FIG. 2 shows an example of a BORT device at line 201 that samples data at regular intervals 204. One preferred embodiment utilizes a sampling interval at least once every 4 seconds, but other intervals could also be used. In this example, the transmitted preamble must be at least 4 seconds long in order for the receiver to acquire the signal prior to data demodulation. In conventional systems, the BORT device would lock onto the signal and continue to demodulate the signal until the message was complete. With a data rate of 19.2 kilobits per second (kbps), a 100-bit data message would require roughly 5 milliseconds to transmit. The ratio of 4 second transmittal preamble to the 5 millisecond (data message) ratio represents an 800-to-1 overhead penalty for the 4 second preamble.

FIG. 2 depicts a BORT system timing schedule according to the present invention. Three timelines are depicted representing three typical devices in a BORT system. BORT #1 is a remote battery operated device whose functions are depicted on line 201. BORT #2 is a second remote battery operated device whose functions are depicted on line 202. Note that the remote devices are not time synchronized and will drift in time, dependent on the precision and drift accuracy of their respective local oscillators. The system transceiver for the BORT system is depicted on line 203. The system transceiver is assumed to have line power, and is therefore not constrained by the power limitations of the remote devices.

All three timelines show blocks (e.g. 205, 206 . . . 212) when the devices are performing BORT communication functions. The remote devices, BORT #1 and BORT #2, are in an active state only during the blocks depicted. The devices remain in a reduced power mode (i.e., a sleep mode) during all other time intervals. The system transceiver is in constant receive mode while not transmitting data 212. While in constant receive mode, the system transceiver stands ready to collect and process the unsolicited supervisory messages from the remote devices (206 and 208). Two way communication is provided between the BORT devices and the system transceiver using an alternating sleep and poll method coupled with unsolicited supervisory and alarm messages.

Supervisory and alarm messages are initiated by the remote BORT devices. The devices send supervisory messages autonomously on a random or a periodic time base for the expressed purpose of maintaining positive communication to the system transceiver. Routine or non-time critical information, such as for example identification or status information, is transmitted by the BORT remote devices on a schedule which satisfies the system information requirements. The system transceivers remain predominately in listen mode, ready to receive the sporadic supervisory messages. Collision and overlap between the BORT devices is resolved through redundancy. Blocks 206 and 208 depict two such supervisory messages from BORT #1 and BORT #2, respectively. In each supervisory transmission, the system transceiver receives the burst in blocks 207 and 209, respectively. Alarm messages are fundamentally the same as supervisory messages, the only difference being the fact that alarm messages entail the timely transference of important system information. Alarm messages typically supersede the sporadic message rate associated with the supervisory data.

Interleaved with supervisory and alarm functions, the BORT remote devices poll for system transceiver messages. The BORT devices typically wake up on a schedule to poll for data on a chance that the system transceiver is attempting to communicate data. The poll interval 204 is short, or long, or pseudo-random, with a requisite requirement being that the system transceiver transmit a long preamble which is at least equal to the longest poll interval.

Blocks 205, 220 and 221 depict poll functions for the remote BORT devices. The BORT device wakes up, samples data and upon seeing no data (as in the case of block 205) resumes a reduced-power state awaiting the next schedule poll or supervisory event. When the system transceiver needs to transmit information to the BORT device or devices, it transmits a long preamble 212 whose duration exceeds the maximum poll interval of the BORT devices. At some point during this long preamble (i.e at steps 210 or 211), each BORT device will wake up for a poll and detect the system transceiver.

Upon detecting the system transceiver, the BORT device can remain awake, awaiting the start of the data packet as previously disclosed. However, to remain awake is costly from a power perspective and presents problems associated with maintaining code phase lock for DSSS systems. The present invention overcomes these problems by allowing the BORT devices to conserve power in a timed sleep state. The BORT devices need only stay awake long enough to demodulate a count value (e.g. 214 and 217 in the header) in order to seed the timed sleep counter.

The long preamble 212 represents a repeated sequence of shorter leader sections 213 interleaved with a changing count value 214. Note that, according to the present invention “preamble” refers to an entire transmission that precedes the data message. The “preamble” includes both unmodulated “leader” sections and count sequences. As shown in FIG. 2, the present invention utilizes a leader 215 on the order of 136 bits followed by a sync pattern 216 followed by the count value 217 and finally appended with an optional parity bit 218. Immediately following the last bit in the count packet, a new leader is started followed by a new count value until such a time as the worst case poll interval is spanned, whereby the count value is replaced with the actual data packet 219.

The present invention therefore increases battery life of the BORT devices by embedding a series of counter values into the preamble. Once the BORT device has acquired the preamble, the counter information instructs by way of the count value how much of the preamble remains prior to data modulation. The BORT device then returns to a timed sleep interval, and subsequently wakes up in time to re-acquire the signal and demodulate data.

Upon termination of the timed sleep interval, the BORT device awakens to collect the data packet, discerns the specific relevance or required action, then returns to a normal pattern of sleeping and polling as before.

In another embodiment of the present invention, the BORT device acknowledges receipt of the polling message using a field in the next supervisory message or an alarm message with a pseudo random delay to reduce a probability of a collision with another BORT device.

Without any count information in the preamble, the BORT device will, on average, be active for half of the preamble length. One benefit of the present invention is that, if the preamble has 10 embedded counter values, the BORT device may be active for between one tenth and one fifth of the preamble length, conserving battery life. A preamble with more embedded counter values will enable the BORT device to remain active for even less of the preamble duration, conserving still more battery life.

In another embodiment of the present invention, BORT devices with large frequency error alternatively wake up multiple times during the preamble to verify their respective timing. Table 1 shows the calculations for determining the number of counter messages embedded in the long preamble.

The long preamble needs to be divided into a reasonable number of portions. The derivation of this value is shown in Table 1. The calculations in Table 1 are based on a 19.2 kbps data rate (˜52 μs per bit), an overall message length of 4 seconds, and an error in the sleep timer of the BORT device (8 ms).

TABLE 1

| | 4 s/8 ms = 500 divisions | | |
|---|---|---|---|
| | 4 s/512 divisions = 7.8 ms per division | | |
| | 7.8 ms/division/52 us/bit = 150 bits/division | | |
| 4 | bits sync | 150 | bits per division |
| 9 | bits data | − 14 | bits information |
| + 1 | bit parity | 136 | bits leader |
| 14 | bits | | |

The number of divisions is derived by dividing the poll interval (4 seconds) by the sleep timer error (˜8 ms). The calculated value (500) can be represented by a 9-bit value. Subsequently, the 9-bit counter can sub-divide the long preamble by a total of 512 sections. With 512 divisions, each section would be 7.8 ms long. This results in each division having 150 bits in duration. This in turn yields a 136-bit leader section.

Initial Signal Correlation

The introduction of counter information into a long preamble is used to solve a battery life problem. This approach, however, introduces another problem. The signal acquisition process of the transceiver assumes that the transmitter will be transmitting a known data pattern such as a string of constant logic ‘1’ values in the preamble. With count information embedded in the preamble, this assumption is no longer valid. The following background information is given for explanation:

To acquire the transmitted signal, the receiver of the present invention wakes up and samples one code period (typically one bit) of data. The presence of data indicates the presence of a signal transmission. However, the absence of data may or may not indicate the absence of a data transmission. If amplitude modulation is used, the transmitter may be transmitting valid data and the receiver will not detect the presence of data. For example, in DSSS Amplitude Shift-Keyed (ASK) systems, the presence of an ‘expected’ data bit is interpreted as a logic ‘1’, and the absence of an ‘expected’ data bit is interpreted as a logic ‘0’. This principal also applies to narrowband Amplitude Modulation (AM) communications. Note, however, that this assumption is only valid after the receiver has positively locked on to a transmitted data signal. For initial signal acquisition, the absence of data may be due to the fact that there is no signal. Therefore, according to the present invention the initial signal acquisition takes place while a known data condition is being transmitted. This condition can be somewhat minimized in DSSS systems using PSK (Phase Shift Keyed), data modulation such as BPSK (Binary Phase Shift Keyed), QPSK (Quadrature Phase Shift Keyed) or M-ary Phase Shift Keying. A search algorithm discerns mark-space alignment including the sampling of a symbol which may contain portions of both.

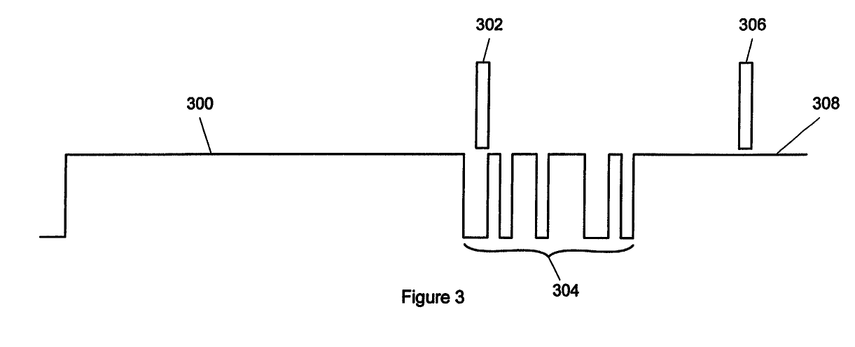

In order to overcome this problem, the ASK/AM receiver of the present invention takes two data samples. The samples will be separated by a sufficient interval in order to insure that if the first sample is taken during a counter interval (a period when logic ‘0’ values and logic ‘1’ values are intermixed), then the next sample will be taken during the normal leader time, when all logic ‘1’ values are being transmitted. FIG. 3 shows a transmitted signal with a first leader section 300, a data modulation section 304, and a second leader section 308. The diagram shows a receiver taking a first data sample 302 during the data modulation section 304. The receiver then takes a second data sample 306 during the following leader section 308.

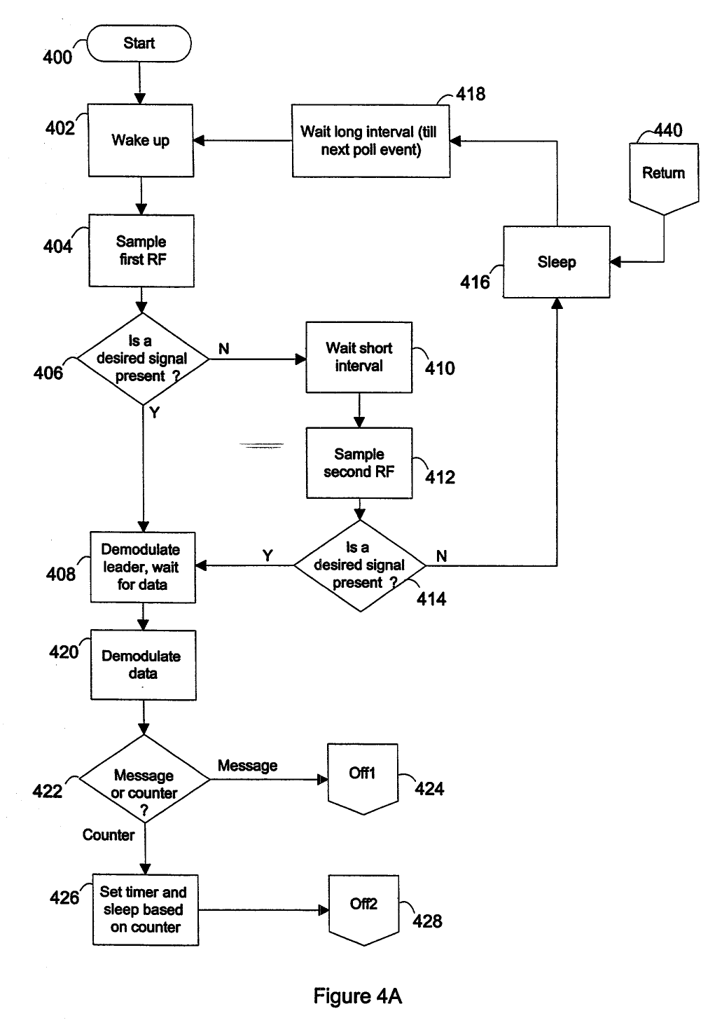

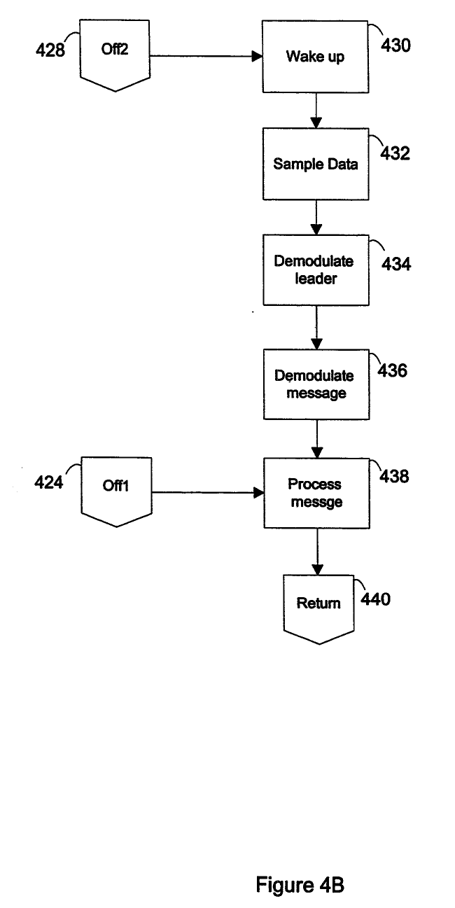

Steps in this process are explained with reference to FIGS. 4A and 4B where the method begins in step 400 and then in step 402, where the BORT device wakes up from a low power sleep mode. The device will take a first data sample in step 404 and then in step 406 makes a trip decision based on whether or not a desired RF signal is present. If a desired signal is present, then the BORT device will continue demodulation until the leader portion of the message is complete in step 408. If, from the determination in step 406, no signal is present, then in step 410 the BORT device will remain active and wait a short interval 410, and in step 412 take a second RF sample. In step 414, the BORT device makes a trip decision based on whether or not a desired RF signal is present. If the signal is present, the process proceeds to step 408 as mentioned earlier. If no signal is present, the process proceeds to step 416 where the BORT device enters a low power sleep mode and then in step 418 waits a long interval until the next supervisory, alarm, or poll event. After the long interval in step 418 has expired, the BORT device wakes up in step 402.

Once the leader portion of the message is complete in step 408, the BORT device demodulates the data portion in step 420 and then decides in step 422 whether the data represents a valid message or a counter value. If the data represents a counter value, then in step 426 the device sets a sleep timer appropriately.

As shown in FIG. 4B, the device sleeps until step 428 and then wakes up at step 430, and takes an additional data sample in step 432 to reacquire the signal. The BORT device demodulates the leader in step 434 and the data message in step 436. In step 438, the BORT device then carries out any command embedded in the data message.

From step 422, if the BORT device detects a message, the process proceeds to step 424 and then to step 438. From step 438 and then step 440, the process enters a sleep mode at step 416 and waits at step 418 for the active state at step 402.

Table 2 shows the one/zero pattern of a sync nibble with potential counter values. The ‘0111’ pattern of the sync nibble is used so that the receiver will be able to differentiate between the leader (prior to the sync nibble) and the data (after the sync nibble). Table 2 shows all 16 patterns that can be generated with a 4-bit count sequence. The ‘Parity’ portion of the Table (separated into an Even section and an Odd section) is broken into columns A, B, and C. The A column shows the value of the parity bit associated with each bit pattern. The B column shows the total number of ‘0’ values used in the sync, data, and parity. The number in column C represents the number of times two consecutive ‘0’ values occur.

The possibility of sampling during a ‘0’ transmission does affect the bit-error rate (BER) of the system throughput. The present invention operates at a target BER 0.5×10⁻³ at maximum sensitivity. From Table 1, each division of the long preamble would contain 150 bits, and each of those divisions would contain an average of 5 ‘0’ values each. If the same carrier-to-noise ratio (CNR) is maintained, the BER would increase to 0.6×10⁻³, based on BER curves for on-off key (OOK) modulation techniques disclosed in Dixon. “Spread Spectrum Systems” Third Edition, John Wiley & Sons, 1994, the contents of which are herein incorporated by reference. This tradeoff is acceptable in light of the benefits toward battery life.

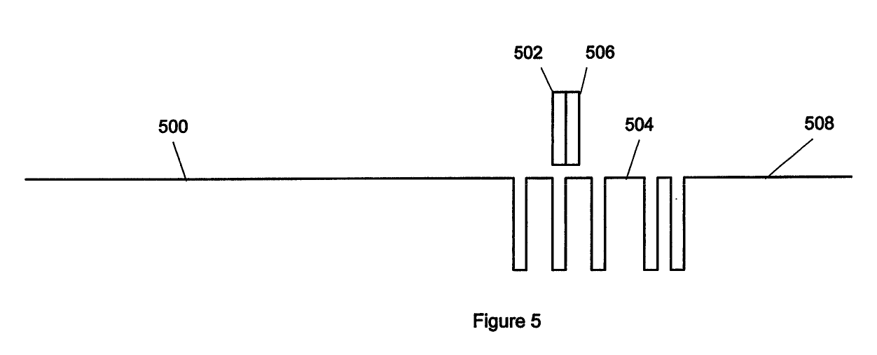

Alternatively, according to the present invention, two consecutive symbols (consecutive code intervals) of data are sampled. FIG. 5 shows a transmitted signal with a first leader section 500, a data modulation section 504, and a second leader section 508. The diagram shows a receiver taking consecutive data samples 502 and 506. It can be seen from FIG. 5 that taking two consecutive data samples reduces the probability of sampling logic ‘0’ values. It is therefore a further object of the present invention to disclose techniques that eliminate the occurrence of consecutive ‘0’ values.

Table 3 shows the number of bits used in a 91-bit leader and a 4-bit data count field. This table shows the probabilities of sampling on a single ‘0’ value as well as the probability of sampling on consecutive ‘0’ values. The probability that two consecutive 0's are sampled can be computed when normal binary sequences are used. The use of a 91-bit leader with the data in Table 1 would produce 100 bits per division.

TABLE 2

| | | | | | | | | Even Parity | | | Odd Parity | | |
|---|---|---|---|---|---|---|---|---|---|---|---|---|---|
| Sync Nibble | | | | Data Nibble | | | | A | B | C | A | B | C |
| 0 | 1 | 1 | 1 | 0 | 0 | 0 | 0 | 1 | 5 | 3 | 0 | 6 | 4 |
| 0 | 1 | 1 | 1 | 0 | 0 | 0 | 1 | 0 | 5 | 2 | 1 | 4 | 2 |
| 0 | 1 | 1 | 1 | 0 | 0 | 1 | 0 | 0 | 5 | 2 | 1 | 4 | 1 |
| 0 | 1 | 1 | 1 | 0 | 0 | 1 | 1 | 1 | 3 | 1 | 0 | 4 | 1 |
| 0 | 1 | 1 | 1 | 0 | 1 | 0 | 0 | 0 | 5 | 2 | 1 | 4 | 1 |
| 0 | 1 | 1 | 1 | 0 | 1 | 0 | 1 | 1 | 3 | 0 | 1 | 4 | 0 |
| 0 | 1 | 1 | 1 | 0 | 1 | 1 | 0 | 1 | 3 | 0 | 0 | 4 | 1 |
| 0 | 1 | 1 | 1 | 0 | 1 | 1 | 1 | 0 | 3 | 0 | 1 | 2 | 0 |
| 0 | 1 | 1 | 1 | 1 | 0 | 0 | 0 | 0 | 5 | 3 | 1 | 4 | 2 |
| 0 | 1 | 1 | 1 | 1 | 0 | 0 | 1 | 1 | 3 | 1 | 0 | 4 | 1 |
| 0 | 1 | 1 | 1 | 1 | 0 | 1 | 0 | 1 | 3 | 0 | 0 | 4 | 1 |
| 0 | 1 | 1 | 1 | 1 | 0 | 1 | 1 | 0 | 3 | 0 | 1 | 2 | 0 |
| 0 | 1 | 1 | 1 | 1 | 1 | 0 | 0 | 1 | 3 | 1 | 0 | 4 | 2 |
| 0 | 1 | 1 | 1 | 1 | 1 | 0 | 1 | 0 | 3 | 0 | 1 | 2 | 0 |
| 0 | 1 | 1 | 1 | 1 | 1 | 1 | 0 | 0 | 3 | 0 | 1 | 2 | 0 |
| 0 | 1 | 1 | 1 | 1 | 1 | 1 | 1 | 1 | 1 | 0 | 0 | 2 | 0 |
| | | | | | | | | | 56 | 15 | | 56 | 16 |

TABLE 3
Calculations based on a four-bit count value:

```
  91 bits leader
  4 bits sync
  4 bits parity
100 bits/division
16 divisions yield 1600 bits
From Table 2, there are 72 occurrences of ‘0’ values
72/1600 = 4.5% chance of sampling a single ‘0’ on the first sample *
From Table 2, there are 15 occurrences of consecutive ‘0’ values
15/1600 = 1.0% chance of sampling consecutive ‘0’ values
* Note that a bit sample will almost always contain portions of two bit intervals. Half of the time, the overlap will contain at least a ½ bit power of a ‘1’ which will result in a 3 dB power loss. This power loss yields a 2.25% chance of sampling degradation with 7 dB impact.
```

Elimination of the Occurrence of Consecutive 0's

The elimination of the occurrence of consecutive 0's is beneficial in amplitude AM/ASK systems. Systems with phase and/or frequency modulation are unaffected. According to the present invention, different approaches can be utilized to eliminate the possibility of sampling consecutive ‘0’ values. Table 4 shows a 4-bit count field that uses bit patterns without consecutive 0's which are weighted as count values 0 through 7. Table 5 shows a 5-bit count field that may use bit patterns without consecutive 0's which are weighted as count values 0 through 12. Table 6 shows a similar 6-bit count field that produces 22 count values. This method could be utilized with more bits to define larger sets of numerical sequences.

TABLE 4

| 4-bit | coded | 4-bit | coded | 4-bit | coded | 4-bit | coded |
|---|---|---|---|---|---|---|---|
| value | value | value | value | value | value | value | value |
| 0000 | X | 0100 | X | 1000 | X | 1100 | X |
| 0001 | X | 0101 | 0 | 1001 | X | 1101 | 5 |
| 0010 | X | 0110 | 1 | 1010 | 3 | 1110 | 6 |
| 0011 | X | 0111 | 2 | 1011 | 4 | 1111 | 7 |

TABLE 5

| 5-bit | coded | 5-bit | coded | 5-bit | coded | 5-bit | coded |
|---|---|---|---|---|---|---|---|
| value | value | value | value | value | value | value | value |
| 00000 | X | 01000 | X | 10000 | X | 11000 | X |
| 00001 | X | 01001 | X | 10001 | X | 11001 | X |
| 00010 | X | 01010 | 0 | 10010 | X | 11010 | 8 |
| 00011 | X | 01011 | 1 | 10011 | X | 11011 | 9 |
| 00100 | X | 01100 | X | 10100 | X | 11100 | X |
| 00101 | X | 01101 | 2 | 10101 | 5 | 11101 | 10 |
| 00110 | X | 01110 | 3 | 10110 | 6 | 11110 | 11 |
| 00111 | X | 01111 | 4 | 10111 | 7 | 11111 | 12 |

TABLE 6

| 6-bit | coded | 6-bit | coded | 6-bit | coded | 6-bit | coded |
|---|---|---|---|---|---|---|---|
| value | value | value | value | value | value | value | value |
| 000000 | X | 010000 | X | 100000 | X | 110000 | X |
| 000001 | X | 010001 | X | 100001 | X | 110001 | X |
| 000010 | X | 010010 | X | 100010 | X | 110010 | X |
| 000011 | X | 010011 | X | 100011 | X | 110011 | X |
| 000100 | X | 010100 | X | 100100 | X | 110100 | X |
| 000101 | X | 010101 | 0 | 100101 | X | 110101 | 14 |
| 000110 | X | 010110 | 1 | 100110 | X | 110110 | 15 |
| 000111 | X | 010111 | 2 | 100111 | X | 110111 | 16 |
| 001000 | X | 011000 | X | 101000 | X | 111000 | X |
| 001001 | X | 011001 | X | 101001 | X | 111001 | X |
| 001010 | X | 011010 | 4 | 101010 | 9 | 111010 | 17 |
| 001011 | X | 011011 | 5 | 101011 | 10 | 111011 | 18 |
| 001100 | X | 011100 | X | 101100 | X | 111100 | X |
| 001101 | X | 011101 | 6 | 101101 | 11 | 111101 | 19 |
| 001110 | X | 011110 | 7 | 101110 | 12 | 111110 | 20 |
| 001111 | X | 011111 | 8 | 101111 | 13 | 111111 | 21 |

In some architectures, it may not be feasible to sample consecutive bit periods. In DSSS systems, time is required to perform a code trip/correlation function. Such trip algorithms are disclosed in U.S. Pat. No. 6,111,911, herein incorporated by reference. In systems where it is not feasible to sample consecutive bits, provisions may be made to sample the data every N bits, where N is a positive integer. For these systems, bit patterns are used where no two ‘0’ values would be separated by N bits.

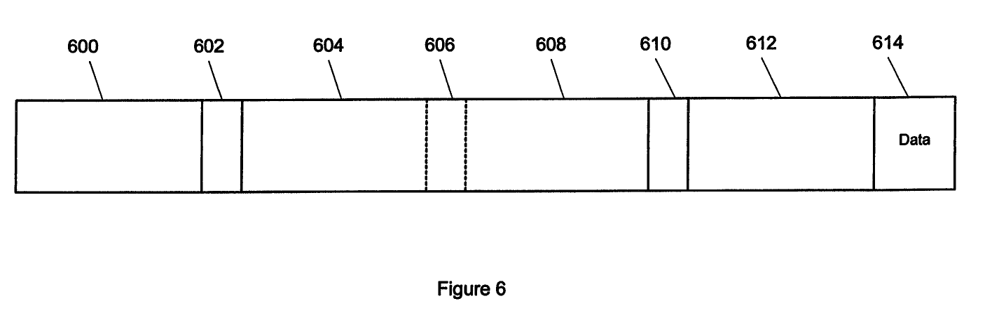

An alternative to the re-defined number sequence is given in FIG. 6. In this method, the number sequences that use consecutive 0's are not used. In reference to FIG. 6, items 600, 604, 608, and 612 represent the short leader sections of the message. Item 614 represents the data message. Items 602 and 610 represent counter values that do not contain consecutive ‘0’ values. Item 606 represents a counter value that contains at least two consecutive ‘0’ values and is therefore not transmitted. Instead, a string of constant known leader values is transmitted during this time.

Another approach is to use a variant of Manchester encoding. In Manchester encoding, a ‘0’ value is defined as ‘10’ and a logic ‘1’ value is defined as ‘01’. In the encoding scheme of the present invention, a ‘0’ is redefined as ‘01’ (or ‘10’) and a ‘1’ is redefined as ‘11’. This approach increases numerical flexibility over the numbering schemes of Tables 4-6 as well as the solution provided in FIG. 6. The probability for sampling on a ‘0’ are reduced in comparison to Manchester encoding due to the double one encoding, i.e. ‘11′’ (e.g., a 0.5 probability for the Manchester encoding is reduced to 0.25 for the double one encoding).

Impact of Bit Error Rate

The following calculations show how modulating the message leader impacts the bit-error rate (BER) in amplitude modulations systems. Given is a receiver that receives a non-modulated (leader) minimal-detectable signal (MDS) with a BER of 0.5×10⁻³.

The following is for one sample at a MDS with all leader values being transmitted:

Given BER=0.5×10⁻³, then BSR=(1−BER)=0.995 where BSR stands for “bit-success rate”

The following is for one sample at a MDS with a modulated signal being transmitted:

Based on 150 bits/division with a 9-bit counter, on average, there are 6 ‘0’ bits per division. Given that a sample can slide over a 1/0 transition, assuming that less than 50% coverage over a “1” is a miss, 6 “0” bits gives 12 bit-times for a miss. 12 bit-times/150 bits per division yields 0.08, as a chance of sampling a “0”, and 1-0.08=0.92, as a chance of sampling a “1”. The probability of success for one sample is given by (0.92)×(0.995)=0.91954. The bit error rate is 1-0.91954 or 0.0846.

The following is for two samples, such that at least one of the samples will occur during the leader portion:

P[failure]=P[all 1's failure]×P[intermixed failure]=(0.005)×(0.0846)=0.000423

BER is 0.000423

The following is for two samples, such that both samples might occur during the modulated portion:

P[failure]=P[intermixed failure]²=(0.0846)²=7.16×10⁻³

BER is 0.00716-3

Sampling for Two Consecutive Code Periods

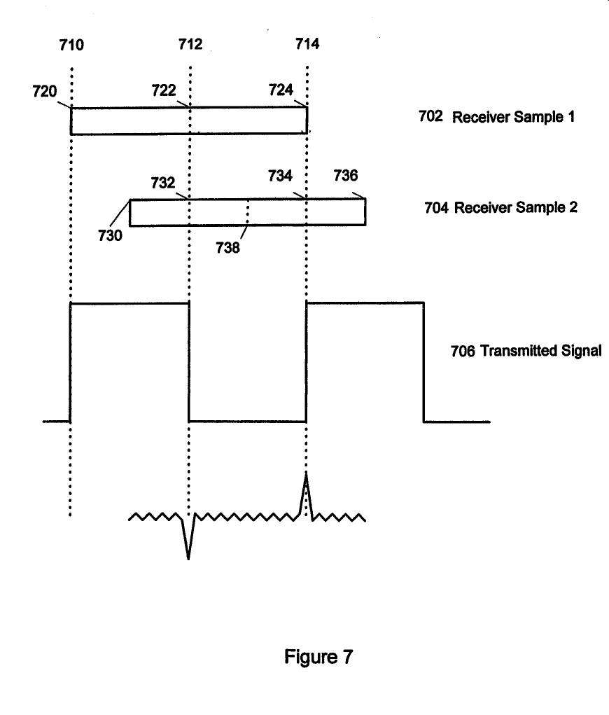

Another embodiment of the present invention involves signal correlation in the presence of an amplitude-modulated signal with non-consecutive zeroes. In this embodiment, a receiver samples for two consecutive sample periods. One example of a signal correlation is shown in FIG. 7, where the transmitted signal is depicted as 706. Receiver samples 1 and 2 (items 702 and 704) are also shown. Vertical lines 710, 712 and 714 are time coincident with the bit boundaries of the transmitted signal 706. The samples are digitized and sequentially stored in a memory that is large enough to hold the entire sample. A preferred embodiment of this memory is a circular buffer.

Receiver sample 702 depicts an ideal condition where the receiver begins sampling 720 coincident with the bit boundary 710. Once the data sample has been stored, the receiver performs a correlation function on the sample beginning at point 720. The correlation function initializes a pointer into the memory array corresponding to the data sample of 720. The correlation function considers all data points between 720 and 722. For this ideal case, the correlation function detects a correlation event and locks onto the received signal.

Receiver sample 704 represents a more realistic condition, where the receiver begins sampling at 730 and stops sampling at 736. Once the data sample has been stored, the receiver performs a correlation function on the sample beginning at point 730. The correlation function initializes a pointer into a memory array corresponding to the data sample of 730. The correlation function includes enough points to span a bit time (code repetition time). In this case, the last data point will be the data point just prior to the data point at 738. The initial correlation function does not detect a correlation event.

The correlation function then increments the pointer into the memory array and performs the correlation on the next set of data points. The correlation function continues incrementing the array pointer until the array pointer points to the memory location corresponding to the data sample taken at 734. The correlation function then performs the correlation on the data points from 734 to 736 and 730 to 732. At this point, the correlation function detects a correlation event.

The correlation function thus increases the probability that “01” sequence in the bit stream will be positively read hence reducing bit error rate.

Parity

As was noted in Table 2, the parity bit cannot be ignored. Tables 4 through 6 showed sequences of binary numbers where certain bit patterns were not used due to their inclusion of consecutive ‘0’ values. When the parity bit is included, even more of the bit patterns from Tables 4 through 6 will have to be excluded from use.

One method according to the present invention to reduce the impact of the parity bit is to use the number sequences from Tables 4 through 6 but encode the parity bit with the double one encoding mentioned previously.

Computer Implementation

The aforesaid methods and system for reducing power consumption in remote communications systems are contained in according to this invention on a computer program product. The computer program product is a storage medium including instructions which can be used to program a computer or a plurality of network computers connected to a network of system transceivers to perform a process of the invention. Storage medium can include, but is not limited to, any type of disc including floppy disc, optical disc, CD ROMs, and magneto optical disc, ROMs, RAMs, EPROMs, EEPROMs, magnetic or optical cards, or any type of medium suitable for storing electronic instructions.

The present invention, as will be apparent to those skilled in the computer art from reading the above descriptions and figures, can be conveniently implemented in general purpose digital computers contained on the system and remoter transceivers and programmed to record the teachings of the present invention. The invention may also be implemented by preparation of applications specific integrated circuits or by interconnecting an appropriate network of conventional component of circuits, as will be readily apparent to those skilled in the art.

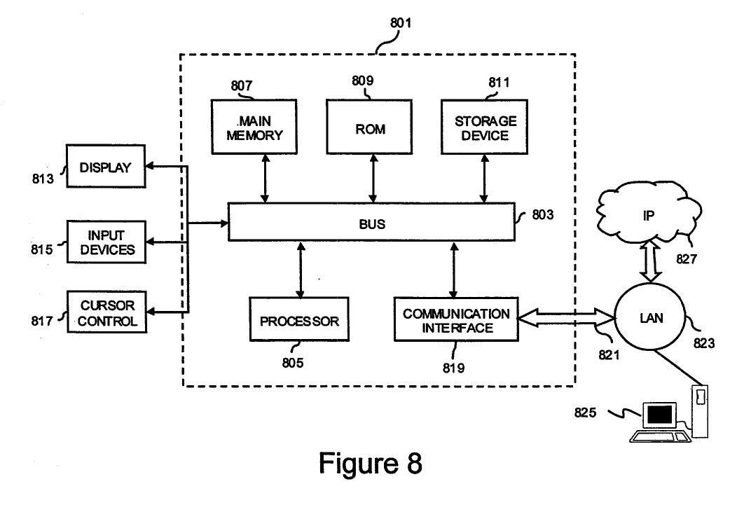

FIG. 8 illustrates a computer system 801 for the computers 130 and 132 in the system and remote transceivers, respectively, upon which an embodiment according to the present invention may be implemented. Computer system 801 includes a bus 803 or other communication mechanism for communicating information, and a processor 805 coupled with bus 803 for processing the information. Computer system 801 also includes a main memory 807, such as a random access memory (RAM) or other dynamic storage device (e.g., dynamic RAM (DRAM), static RAM (SRAM), synchronous DRAM (SDRAM), flash RAM), coupled to bus 803 for storing information and instructions to be executed by processor 805. In addition, main memory 807 may be used for storing temporary variables or other intermediate information during execution of instructions to be executed by processor 805. Computer system 801 further includes a read only memory (ROM) 809 or other static storage device (e.g., programmable ROM (PROM), erasable PROM (EPROM), and electrically erasable PROM (EEPROM)) coupled to bus 803 for storing static information and instructions for processor 805. A storage device 811, such as a magnetic disk or optical disc, is provided and coupled to bus 803 for storing information and instructions.

The computer system 801 may also include special purpose logic devices (e.g., application specific integrated circuits (ASICs)) or configurable logic devices (e.g., generic array of logic (GAL) or reprogrammable field programmable gate arrays (FPGAs)). Other removable media devices (e.g., a compact disc, a tape, and a removable magneto-optical media) or fixed, high density media drives, may be added to the computer system 801 using an appropriate device bus (e.g., a small computer system interface (SCSI) bus, an enhanced integrated device electronics (IDE) bus, or an ultra-direct memory access (DMA) bus). The computer system 801, in particular the system of computer 130 included in the system transceiver, may additionally include a compact disc reader or a compact disc reader-writer unit, each of which may be connected to the same device bus or another device bus.

Computer system 801 may be coupled via bus 803 to a display 813, such as a cathode ray tube (CRT), for displaying information to a computer user. The display 813 may be controlled by a display or graphics card. A variety of other display devices can be used such as an LCD (liquid crystal display) 740 or plasma display device. The computer system includes input devices, such as a keyboard 815 and a cursor control 817, for communicating information and command selections to processor 805. The cursor control 817, for example, is a mouse, a trackball, or cursor direction keys for communicating direction information and command selections to processor 805 and for controlling cursor movement on the display 813.

The computer system 801 performs a portion or all of the processing steps of the invention in response to processor 805 executing one or more sequences of one or more instructions contained in a memory, such as the main memory 807. Such instructions may be read into the main memory 807 from another computer-readable medium, such as storage device 811. One or more processors in a multi-processing arrangement may also be employed to execute the sequences of instructions contained in main memory 807. In alternative embodiments, hard-wired circuitry may be used in place of or in combination with software instructions. Thus, embodiments are not limited to any specific combination of hardware circuitry and software.

As stated above, the system 801 includes at least one computer readable medium or memory programmed according to the teachings of the invention. Stored on any one or on a combination of computer readable media, the present invention includes software for controlling the computer system 801, for driving a device or devices for implementing the invention, and for enabling the computer system 801 to interact with a human user, e.g., a consumer. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 805 for execution. A computer readable medium may take many forms, including but not limited to, non-volatile media, volatile media, and transmission media. Non-volatile media includes, for example, optical, magnetic disks, and magneto-optical disks, such as storage device 811. Volatile media includes dynamic memory, such as main memory 807. Transmission media includes coaxial cables, copper wire and fiber optics, including the wires that comprise bus 803. Transmission media also may also take the form of acoustic or light waves, such as those generated during radio wave and infrared data communications (e.g. communication between the system tranceiver 110 and the remote transceiver 112).

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 805 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 801 may receive the data on the telephone line and use an infrared transmitter to convert the data to an infrared signal. An infrared detector coupled to bus 803 can receive the data carried in the infrared signal and place the data on bus 803. Bus 803 carries the data to main memory 807, from which processor 805 retrieves and executes the instructions. The instructions received by main memory 807 may optionally be stored on storage device 811 either before or after execution by processor 805.

Computer system 801 also includes a communication interface 819 coupled to bus 803. Communication interface 819 provides a two-way data communication coupling to a network link 821 that is connected to a local network (e.g., LAN 823). For example, communication interface 819 may be a network interface card to attach to any packet switched local area network (LAN). As another example, communication interface 819 may be an asymmetrical digital subscriber line (ADSL) card, an integrated services digital network (ISDN) card, or a modem to provide a data communication connection to a corresponding type of telephone line. Wireless links may also be implemented. In any such implementation, communication interface 819 sends and receives electrical, electromagnetic or optical signals that carry digital data streams representing various types of information.

Network link 821 typically provides data communication through one or more networks to other data devices. For example, network link 821 may provide a connection through LAN 823 to a host computer 825 or to data equipment operated by a service provider, which provides data communication services through an IP (Internet Protocol) network 827 (e.g., the Internet 615) or any other suitable network using any known protocol (e.g., IPX). LAN 823 and IP network 827 both use electrical, electromagnetic or optical signals that carry digital data streams. The signals through the various networks and the signals on network link 821 and through communication interface 819, which carry the digital data to and from computer system 801, are exemplary forms of carrier waves transporting the information. Computer system 801 can transmit notifications and receive data, including program code, through the network(s), network link 821 and communication interface 819.

Numerous modifications and variations of the present invention are possible in light of the above teachings. It is therefore to be understood that within the scope of the appended claims, the invention may be practiced otherwise than as specifically described herein.

What is claimed as new and desired to be secured by Letters Patents of the United States is:

1. A system for reducing power consumption in remote communications, comprising:
a system transceiver configured to transmit in a system transceiver message a count value and modulated communication data, said count value indicating a scheduled broadcast time for broadcast of the modulated communication data; and
a remote transceiver configured as the remote communication device to poll for the count value, to conserve power during a time period prior to the scheduled broadcast time, and to synchronize an on-time of the remote transceiver with the scheduled broadcast time.

2. The system of claim 1, wherein the remote transceiver comprises a polling device configured to poll on a predetermined schedule to sample for the count value prior to receiving the system transceiver message.

3. The system of claim 2, wherein the system transceiver comprises a data modulator configured to transmit, over a timed interval which is longer than a time between repeated remote transceiver pollings, a preamble including the count value and is configured to transmit the modulated communication data in a data modulation section.

4. The system of claim 3, wherein the data modulator is configured to generate the preamble with the following components:
a leader section configured with an identifying signal which the remote transceiver recognizes as being transmitted from the system transceiver; and
a synch pattern configured to identify an end of the leader section and a beginning of the data modulation section, said data modulation section to contain count value or message content.

5. The system of claim 4, wherein the identifying signal comprises all logic “1” values.

6. The system of claim 4, wherein the synch pattern comprises a logic “0111” value.

7. The system of claim 4, wherein the synch pattern and the count value comprise at least one of 4-bit, 5-bit, and 6-bit values.

8. The system of claim 7, wherein the polling device is configured to poll for a time period as short as a transmission time for one bit.

9. The system of claim 8, wherein the polling device is configured to poll in at least two consecutive time periods.

10. The system according to claim 8 or 9, wherein the system transceiver comprises an encoder configured to encode at least one of the count values with Manchester encoding.

11. The system according to claim 8 or 9, wherein the system transceiver comprises a remapping mechanism configured to re-map at least one of the count values such that count values with consecutive zeroes are not transmitted.

12. The system of claim 11, wherein the re-mapped count values comprise:
at least one of “01” and “10” for “0”; and
“11” for “1”.

13. The system according to claim 8 or 9, wherein the system transceiver comprises a remapping mechanism configured to re-map at least one of the count values such that count values with zeroes of “N” spacing are not transmitted and the remote transceiver comprises a polling mechanism configured to poll in at least two consecutive time periods with a total interval less than a time duration of said “N” spacing.

14. The system of claim 9, wherein the remote transceiver comprises:
a detection device configured to correlation event occurring when a transmitted signal from the transceiver changes from a low value to a high value; and
a correlation device configured to correlate together high value transmitted signals.

15. The system of claim 14, wherein the correlation device is configured to select a first set of data samples that are high in value and perform a correlation operation on said first set of data samples repetitively with a selected different set of data samples from said first set at least until the correlation function determines that the correlation event has occurred and all data between the two consecutive time periods have been selected.

16. The system of claim 15, wherein the selected different set of data samples comprises a set non-contiguous with the first set of data samples

17. The system of claim 8, wherein the polling mechanism is configured to poll in two non-consecutive time periods with a sampling interval between the two non-consecutive time periods such that one poll is taken during the data modulation section and the other poll is taken during the leader section of the preamble.

18. The system of claim 4, wherein the preamble further comprises a parity value.

19. The system of claim 18, wherein the system transceiver comprises an encoding mechanism configured to encode at least one of the parity values with Manchester encoding.

20. The system of claim 19, wherein the system transceiver comprises a remapping mechanism configured to re-map at least one of the parity values such that count values with consecutive zeroes are not transmitted value.

21. The system of claim 20, wherein the re-mapped parity values comprise:
at least one of “01” and “10” for “0”; and
“11” for “1”.

22. The system of claim 1, wherein the remote transceiver having obtained the count value determines a low-power sleep period prior to the scheduled broadcast time.

23. The system of claim 1, wherein the system transceiver comprises a line-powered transceiver.

24. The system of claim 1, wherein the remote transceiver comprises a battery-operated remote transceiver.

25. The system of claim 1, wherein the remote transceiver comprises a supervisory device configured to broadcast a supervisory message to the system transceiver, the broadcast of the supervisory message maintains positive communication between the remote transceiver and the system transceiver.

26. The system of claim 1, wherein the remote transceiver comprises a broadcast device configured to broadcast an alarm message to the system transceiver, the broadcast of the alarm message transfers status information.

27. A method for reducing power consumption in remote communications, comprising:
transmitting from a system transceiver a count value and modulated communication data, said count value indicating a scheduled broadcast time for broadcast of the modulated communication data;
polling by a remote transceiver for the count value transmitted from the system transceiver;
conserving power in the remote transceiver during a time period prior to the scheduled broadcast time; and
synchronizing an on-time of the remote transceiver with the scheduled broadcast time of the system transceiver.

28. The method of claim 27, wherein the step of polling by a remote transceiver comprises:
polling on a predetermined schedule for the count value when the remote transceiver has not obtained the count information.

29. The method of claim 28, wherein the step of transmitting comprises:
transmitting, over a timed interval which is longer than a time between repeated remote transceiver pollings, the modulated communication data and the count value.

30. The method of claim 29, wherein the step of transmitting the modulated communication data and the count value comprises:
broadcasting an identifying signal in a leader section, wherein the remote transceiver recognizes the identifying signal as being transmitted from the system transceiver; and
broadcasting a synch pattern which identifies an end of the leader section and a beginning of the count value.

31. The method of claim 30, wherein the step of broadcasting an identifying signal comprises:
broadcasting an identifying signal with all logic “1” values.

32. The method of claim 30, wherein the step of broadcasting a synch pattern comprises:
broadcasting a synch pattern of “0111”.

33. The method of claim 30, wherein the steps of broadcasting a synch pattern and transmitting a count value comprise:
broadcasting a synch pattern and a count value with at least one of 4-bit, 5-bit, and 6-bit values.

34. The method of claim 33, wherein the step of polling on a predetermined schedule comprises:
polling for time periods as short as a transmission time of one bit.

35 The method of claim 34, wherein the step of polling comprises:
polling in at least two consecutive time periods.

36. The method according to claim 35, wherein the step of transmitting the count value comprises:
encoding count values with Manchester encoding.

37. The method according to claim 35, wherein the step of transmitting the count value comprises:
re-mapping count values such that count values with consecutive zeroes are not used.

38. The method of claim 37, wherein the step of re-mapping count values comprises:
re-mapping “0” as at least one “01” and “10”; and
re-mapping “1” as “11”.

39. The method according to claim 35, wherein the step of transmitting the count value comprises:
re-mapping count values such that count values with zeroes of “N” spacing are not transmitted; and
polling in at least two consecutive time periods with a total interval less than a time duration of said “N” spacing.

40. The method of claim 35, wherein the step of polling with a remote transceiver comprises:
performing a correlation function which detects a correlation event occurring when a transmitted signal from the transceiver changes from a low value to a high value; and
correlating together high value transmitted signals.

41. The method of claim 40, wherein the step of performing a correlation function comprises:
selecting a first set of data samples that are high in value;
performing a correlation operation on said first set of data samples repetitively with a selected different set of data samples from said first set at least until the remote transceiver determines that the correlation event has occurred and all data samples between the two consecutive time periods have been selected.

42. The method of claim 41, wherein the step of performing a correlation operation a selected different set comprises:
selecting a set non-contiguous with the first set of data samples.

43. The method of claim 30, wherein the step of transmitting the modulated communication data and the count value further comprises:
broadcasting a parity value.

44. The method of claim 43, wherein the step of broadcasting a parity value comprises:
encoding at least one of the parity values with Manchester encoding.

45. The method of claim 44, wherein the step of broadcasting a parity value comprises:
re-mapping at least one of the parity values such that parity values with consecutive zeroes are not transmitted.

46. The method of claim 43, wherein the step of re-mapping at least one of the parity values comprises:
re-mapping “0” as at least one “01” and “10”; and
re-mapping “1” as “11”.

47. The method of claim 34, wherein the step of polling by a remote transceiver comprises:
polling in two non-consecutive time periods with a sampling interval between the two non-consecutive time periods such that, when one poll is taken during the data modulation section, the other poll is taken during the leader section of the packet message.

48. The method of claim 27, wherein said step of conserving power comprises:
determining a low-power sleep period prior to the on-time of the remote transceiver when the remote transceiver has obtained the count value.

49. The method of claim 27, further comprising:
acknowledging receipt of the count value by the remote transceiver.

50. The method of claim 27, further comprising:
broadcasting with the remote transceiver a supervisory message to the system transceiver, wherein broadcast of the supervisory message maintains positive communication between the remote transceiver and the system transceiver.

51. The method of claim 27, further comprising:
broadcasting with the remote transceiver an alarm message to the system transceiver, wherein broadcast of the alarm message transfers system status information.

52. A system for acquiring a signal in remote communications comprising:
a system transmitter configured to transmit a signal which does not contain more than one “0” value symbol, said signal including a leader section and a data section;
a receiver configured to sample and store data samples from the transmitted signal including at least two symbols for at least two consecutive time periods; and
a correlation operator in the receiver configured to sequence through the stored data samples using a correlator of a length equal to one time period to increase a probability that a “01” sequence is read.

53. The system of claim 52, wherein the data samples are digitized and sequentially stored in a memory.

54. The system of claim 52, wherein the memory is a circular buffer.

55. The system of claim 52, where the leader section does not contain more than one consecutive “0” value symbol.

56. A method for acquiring a signal in remote communications, comprising:
transmitting a signal which does not contain more than one “0” value symbol, said signal including a leader section and a data section;
sampling and storing data samples from the transmitted signal including at least two symbols for at least two consecutive time periods; and
sequencing through the stored data samples with a correlator of a length equal to one time period to increase a probability that a “01” sequence is read.

57. The method of claim 56, wherein the step of sampling comprises:
digitizing the data samples; and
storing the digitized data samples sequentially in a memory.

58. The method of claim 56, wherein the step of storing comprises:
storing the digitized data samples in a circular buffer.

59. The method of claim 56, where the transmitting comprises:
transmitting a leader section with no more than one consecutive “0” value symbol.

60. A computer readable medium containing program instructions for execution on a computer system, which when executed by the computer system, causes the computer system to perform the steps of the method recited in anyone of claims 27-51 and 56-59.

61. A computer readable medium containing program instructions for execution on a computer system, which when executed by the computer system, causes the computer system to perform the steps of:
polling by a remote transceiver for a count value transmitted from a system transceiver;
conserving power in the remote transceiver during a time period prior to a scheduled broadcast time of modulated communication data from the system transceiver; and
synchronizing an on-time of the remote transceiver with the scheduled broadcast time of the system transceiver.

62. The computer readable medium of claim 61, wherein the step of polling by a remote transceiver comprises:
polling on a predetermined schedule for the count value when the remote transceiver has not obtained the count information.

63. The computer readable medium of claim 61, wherein the step of polling by a remote transceiver comprises:
polling in two non-consecutive time periods with a sampling interval between the two non-consecutive time periods such that, when one poll is taken during the data modulation section, the other poll is taken during the leader section of the packet message.

64. The computer readable medium of claim 61, wherein said step of conserving power comprises:
determining a low-power sleep period prior to the on-time of the remote transceiver when the remote transceiver has obtained the count value.
